(19) United States
(12) Patent Application Publication
(10) Pub. No.: US 2010/0056091 A1
(43) Pub. Date: Mar. 4, 2010

(54) DEVICE AND METHOD FOR REDUCING LEAKAGE SIGNAL

(75) Inventors: Seunghyun JANG, Daejeon (KR); Bong Hyuk PARK, Daejeon (KR); Seung Sik LEE, Daejeon (KR); Sangsung CHOI, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTITUTE, Daejeon (KR)

(21) Appl. No.: 12/542,345

(22) Filed: Aug. 17, 2009

(30) Foreign Application Priority Data
Aug. 29, 2008 (KR) 10-2008-0085334

(51) Int. Cl. H04B 17/00; H04B 1/06

(52) U.S. Cl. 455/226.1; 455/256

(57) ABSTRACT

The present invention relates to a leakage signal reducing device and method. The present invention uses a signal with varied phase and gain output by a local oscillator to eliminate a leakage signal leaked by a local oscillator to a frequency converter.

### CROSS-REFERENCE TO RELATED APPLICATION

This application claims priority to and the benefit of Korean Patent Application No. 10-2008-0085334 filed in the Korean Intellectual Property Office on Aug. 29, 2008 the entire contents of which are incorporated herein by reference.

### BACKGROUND OF THE INVENTION

(a) Field of the Invention

The present invention relates to a leakage signal reducing device and method, and particularly, it relates to a leakage signal reducing device and method in a multi-band signal generating system.

(b) Description of the Related Art

A conventional device for reducing a leakage signal of a local oscillator attenuates leakage power by correcting a DC offset at an input terminal of a frequency converter. Therefore, it is difficult to attenuate leakage power generated by other factors such as components that leak because of substrate coupling or parasitic components of a circuit.

Also, studies and developments for leakage power reducing devices appropriate for a multi-band signal generator for realizing recent wideband communication such as the multi-band and ultra-wideband (UWB) have occurred.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a device and method for reducing a leakage signal for efficiently eliminating the leakage signal generated by a local oscillator in a system for generating multi-band signals.

An exemplary embodiment of the present invention provides a method for reducing a leakage signal in a system for generating a multi-band signal including: generating a first frequency signal through a local oscillator; generating a second frequency signal by dividing the first frequency signal with a divider; generating a third frequency signal through a frequency converter by using the first frequency signal and the second frequency signal; generating a first signal by adjusting a phase and a gain of the first frequency signal through a variable phase transistor and a variable gain adjuster; generating a second signal by adding the first signal and the third frequency signal; and controlling a phase adjust value of the variable phase transitor and a gain adjust ratio of the variable gain adjuster based on power of the second signal so as to reduce the leakage signal included in the third frequency signal.

Another embodiment of the present invention provides a device for reducing a leakage signal in a system for generating a multi-band signals, including: a local oscillator for generating a first frequency signal; a divider for generating a second frequency signal by dividing the first frequency signal; a frequency converter for generating a third frequency signal by using the first frequency signal and the second frequency signal; a variable phase transitor for adjusting and outputting a phase of the first frequency signal; a variable gain amplifier for adjusting and outputting a gain of an output signal of the variable phase transitor; an operator for operating the third frequency signal and an output signal of the variable gain amplifier; and a controller for controlling a phase adjust value of the variable phase transitor and a gain adjust ratio of the variable gain amplifier so as to reduce power of the signal output by the operator. According to the present invention, the leakage signal caused by the local oscillator can be efficiently eliminated in the multi-band signal generating system.

### BRIEF DESCRIPTION OF THE DRAWINGS

FIG. 1 shows a device for reducing a leakage signal according to an exemplary embodiment of the present invention.

FIG. 2 shows an output signal of a frequency converter including a leakage signal leaked to an output of the frequency converter by a local oscillator according to an exemplary embodiment of the present invention.

FIG. 3 shows a leakage signal leaked to an output of a frequency converter by a local oscillator according to an exemplary embodiment of the present invention.

FIG. 4 shows a frequency spectrum for an output signal of a frequency converter of FIG. 3 according to an exemplary embodiment of the present invention.

FIG. 5 shows an output signal of an operator according to an exemplary embodiment of the present invention.

FIG. 6 shows a leakage signal included in a signal output by an operator according to an exemplary embodiment of the present invention.

FIG. 7 shows a frequency spectrum of a signal output by an operator of FIG. 5 according to an exemplary embodiment of the present invention.

FIG. 8 shows a flowchart of a leakage signal reducing method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

A device and method for reducing a leakage signal in a system for generating a multi-band signal according to an exemplary embodiment of the present invention will now be described with reference to accompanying drawings.

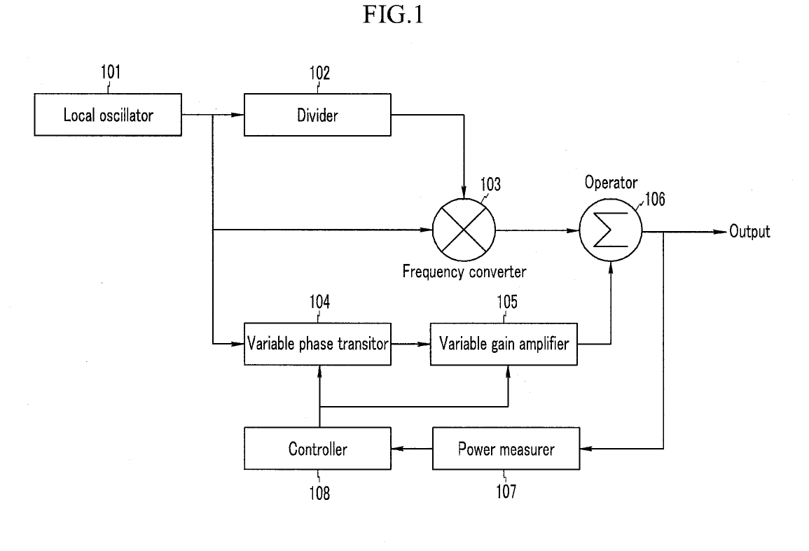

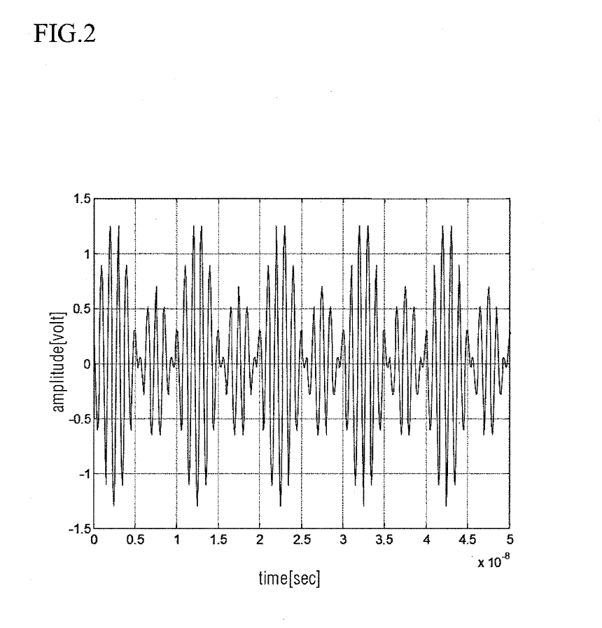

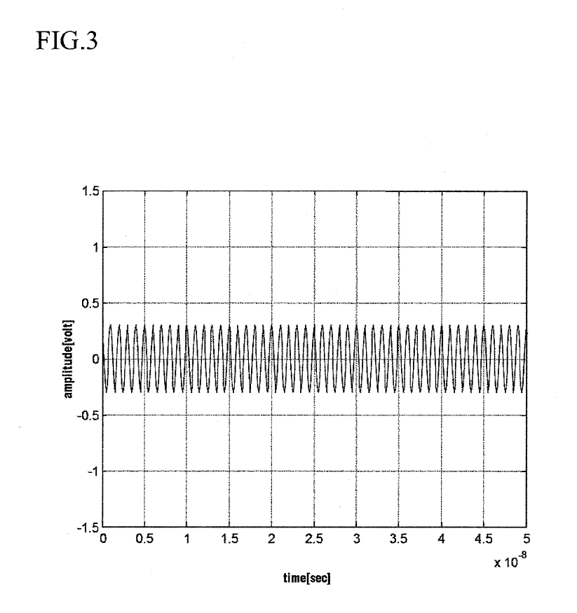

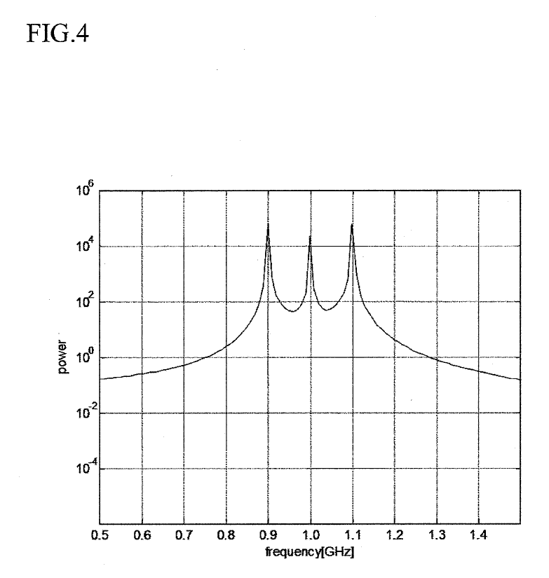

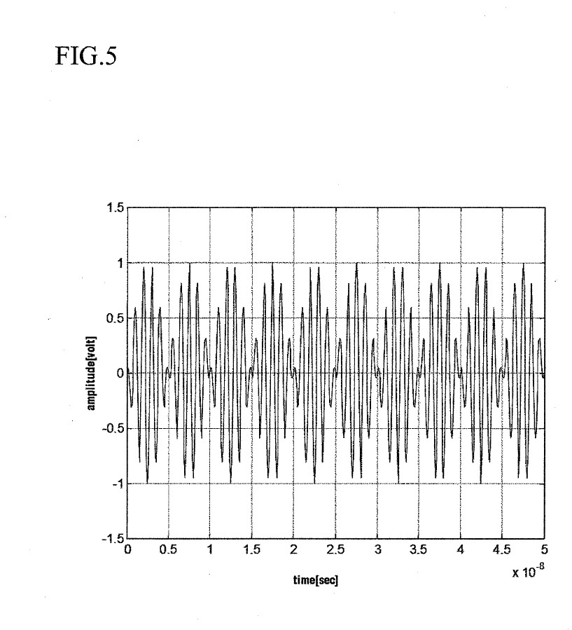

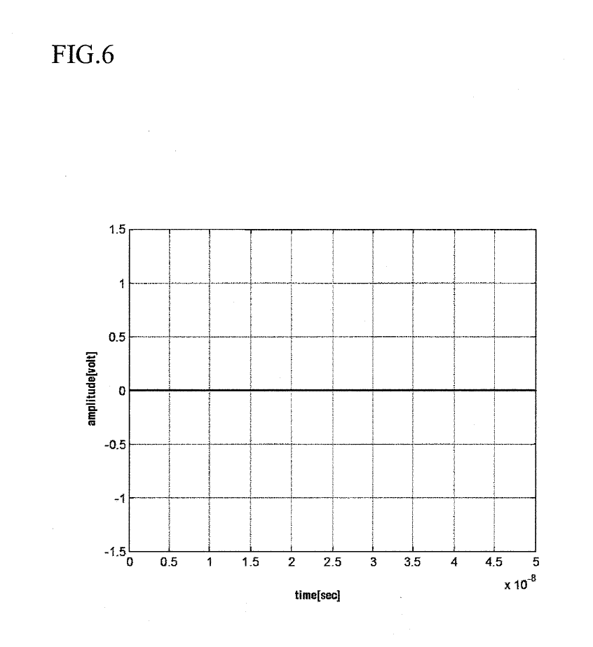

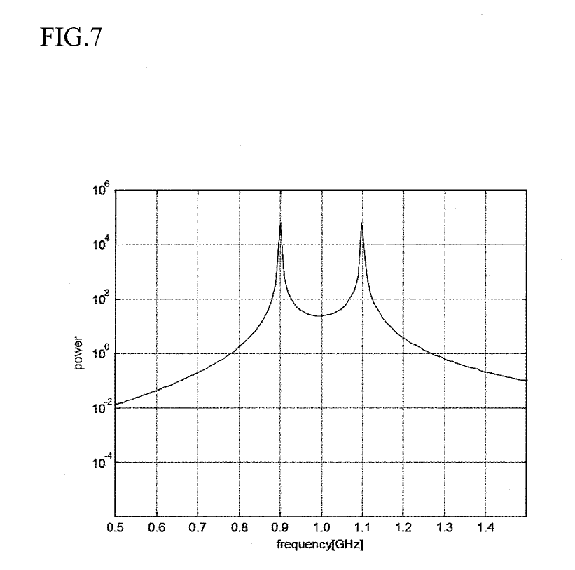

FIG. 1 shows a device for reducing a leakage signal according to an exemplary embodiment of the present invention. Also, FIG. 2 shows an output signal of a frequency converter including a leakage signal caused by a local oscillator according to an exemplary embodiment of the present invention, FIG. 3 shows a leakage signal caused by a local oscillator included in an output signal of a frequency converter of FIG. 2, and FIG. 4 shows a frequency spectrum for an output signal of a frequency converter shown in FIG. 2. Further, FIG. 5 shows an output signal of an operator according to an exemplary embodiment of the present invention, FIG. 6 shows a leakage signal included in a signal output by an operator, and FIG. 7 shows a frequency spectrum of a signal output by an operator of FIG. 5.

Referring to FIG. 1, the leakage signal reducing device includes a local oscillator 101, a divider 102, a frequency converter 103, a variable phase transitor 104, a variable gain amplifier 105, an operator 106, a power measurer 107, and a controller 108.

The local oscillator 101 generates a signal of a first frequency, and the divider 102 divides a frequency of the first frequency signal output by the local oscillator 101 to output a signal of a second frequency.

The frequency converter 103 outputs a signal of a third frequency by using the first frequency signal output by the local oscillator 101 and the second frequency signal output by the divider 102. Here, in the ideal case, the third frequency signal output by the frequency converter 103 is a signal of a frequency bandwidth corresponding to the sum of the first frequency and the second frequency, or a signal of a frequency bandwidth corresponding to the difference between the first frequency and the second frequency.

However, the third frequency signal (Mixer_{OUTPUT}) output by the frequency converter 103 can include a leakage signal leaked from the local oscillator 101 to the frequency converter 103 in addition to the signal of the frequency bandwidth corresponding to the sum or the difference of the first frequency and the second frequency as expressed in Equation 1.

Mixer_{OUTPUT}=cos(2πf_{LO}t)×sin(2πf_{IF}t)+L×cos(2πf_{LO}t) (Equation 1)

Here, cos(2πf_{LO}t) represents the first frequency signal output by the local oscillator 101, and f_{LO} indicates the first frequency. Also, sin(2πf_{IF}t) represents the second frequency signal output by the divider 102, and f_{IF} indicates the second frequency. Further, L represents the ratio for leaking the output signal of the local oscillator 101 to the output of the frequency converter 103 because of many factors, and L×cos(2πf_{LO}t) shows a leakage signal leaked to the output of the frequency converter 103 by the local oscillator 101.

FIG. 2 to FIG. 4 respectively show the case in which when the first frequency signal is the signal of 1 GHz and the second frequency signal is the signal of 0.1 GHz, the output signal (Mixer_{OUTPUT}) of the frequency converter 103 including a leakage signal caused by the local oscillator 101, the leakage signal (L×cos(2πf_{LO}t)) of the local oscillator 101, and the frequency spectrum of the signal (Mixer_{OUTPUT}) output by the frequency converter 103. Referring to FIG. 3, the leakage signal caused by the local oscillator 101 is a narrowband signal with no signal therein. Also, referring to FIG. 4, the signal output by the frequency converter 103 includes the signal of 1 GHz that is the leakage signal caused by the local oscillator 101 in addition to the signals of 1.1 GHz and 0.9 GHz corresponding to the sum and the difference of the signals of 1 GHz and 0.1 GHz, and the frequency of the leakage signal has the same frequency as the output signal of the local oscillator 101. Therefore, in the exemplary embodiment of the present invention, the output signal of the local oscillator 101 having the same frequency as the leakage signal, that is, the first frequency signal, is used in order to reduce the leakage signal of the local oscillator 101.

Referring to FIG. 1 again, the variable phase transitor 104 varies the phase of the first frequency signal output by the local oscillator 101 and outputs a varied signal, and the variable gain amplifier 105 varies the gain of the phase varied signal output by the variable phase transitor 104 and outputs a resultant signal. That is, the leakage signal reducing device varies the phase and the gain of the first frequency signal output by the local oscillator 101 to generate a signal for reducing the leakage signal.

The signal output by the variable gain amplifier 105 is applied to the operator 106, and the operator 106 adds the third frequency signal output by the frequency converter 103 and the signal output by the variable gain amplifier 105, and outputs an added signal. Here, the signal (Adder_{OUTPUT}) output by the operator 106 can be expressed as Equation 2.

$$\begin{matrix}{Adder}_{OUTPUT} = {Mixer}_{OUTPUT +} A \times cos ( 2 π {f}_{LO} t + Ο ) - \\ = cos ( 2 π {f}_{LO} t ) \times sin ( 2 π {f}_{IF} t ) + L \times \\ cos ( 2 π {f}_{LO} t ) {}_{+} A \times cos ( 2 π {f}_{LO} t + Ο ) -\end{matrix} \qquad ( Equation 2 )$$

Here, A×cos(2πf_{LO}t+θ)) represents the signal output by the variable gain amplifier 105, θ indicates the phase adjusted value at the variable phase transitor 104, and A signifies the gain adjust ratio at the variable gain amplifier 105.

Referring to Equation 2, the phase (2πf_{LO}t+θ) of the signal output by the variable phase transitor 104 is an odd number times 180 degrees, and when the gain adjust ratio A of the variable gain amplifier 105 corresponds to the leakage ratio L of the leakage signal, the two signals are offset and the leakage signal is also offset.

FIG. 5 to FIG. 7 show the output signal (Adder_{OUTPUT}) of the operator 106, the signal (L×cos(2πf_{LO}t)₊A×cos(2πf_{LO}t+θ)) of the sum of the output signal of the variable gain amplifier 105 and the leakage signal, and the frequency spectrum of the signal output by the operator 106 when the signal having varied the phase and the gain of the signal output by the local oscillator 101, that is, the output signal of the variable gain amplifier 105, is offset with the leakage signal. When the output signal of the variable gain amplifier 105 and the leakage signal are offset with each other, as shown in FIG. 6, the output signal of the operator 106 includes the signals (signal of 1.1 GHz and signal of 0.9 GHz) corresponding to the sum and the difference of the first frequency signal (1 GHz) and the second frequency signal (0.1 GHz) as shown in FIG. 7, and the leakage signal component is eliminated.

Referring to FIG. 1 again, the power measurer 107 measures power of the signal output by the operator 106, and outputs it. Here, the power measurer 107 can measure power of frequency bandwidths of signals output by the operator 106, and can measure power of the signal having the same frequency bandwidth as the first frequency signal output by the local oscillator 101.

The controller 108 outputs a control signal for controlling a phase adjust value of the variable phase transitor 104 and a gain adjust ratio of the variable gain amplifier 105 so as to reduce power of the signal output by the operator 106 based on the power value measured by the power measurer 107. That is, in order to eliminate power caused by the leakage signal from the power of the third frequency signal output by the frequency converter 103, the controller 108 controls the variable phase transitor 104 and the variable gain amplifier 105 so that the signal output by the variable gain amplifier 105 may have the same frequency and gain as the leakage signal and may have an opposite phase thereof. Here, the controller 108 can output a control signal for controlling the variable gain amplifier 105 after outputting a control signal for controlling the variable phase transitor 104, or it can output a control signal for controlling the variable phase transitor 104 after outputting a control signal for controlling the variable gain amplifier 105.

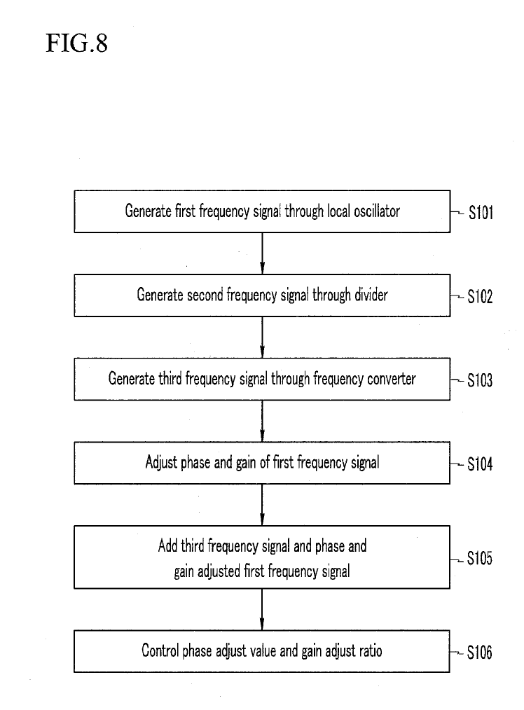

FIG. 8 shows a flowchart of a leakage signal reducing method according to an exemplary embodiment of the present invention.

Referring to FIG. 8, the local oscillator 101 generates the first frequency signal to output it to the divider 102, the frequency converter 103, and the variable phase transitor 104 (S101). The divider 102 outputs the second frequency signal generated by dividing the first frequency signal output by the local oscillator 101 to the frequency converter 103 (S102), and the frequency converter 103 outputs the third frequency signal by using the first frequency signal output by the local oscillator 101 and the second frequency signal output by the divider 102 (S103).

The phase of the first frequency signal input to the variable phase transitor 104 is varied by variable phase transitor 104 and the gain thereof is adjusted by the variable gain amplifier 105, and they are then output in order to offset the leakage signal leaked as an output of the frequency converter 103 by the local oscillator 101 (S104).

The operator 106 adds the third frequency signal output by the frequency converter 103 and the signal output by the variable gain amplifier 105 and outputs the added signal, and the output signal of the variable gain amplifier 105 is added so as to reduce the leakage signal from the third frequency signal output by the frequency converter 103 (S105).

The power measurer 107 measures power of the signal output by the operator 106, and the controller 108 used the signal power measured by the power measurer 107 to generate a phase adjust value of the variable phase transitor 104 and a gain adjust ratio of the variable gain amplifier 105 for eliminating the leakage signal from the output signal of the frequency converter 103. The power measurer 107 controls the variable phase transitor 104 and the variable gain amplifier 105 based on the generated phase adjust value and the gain adjust ratio (S106).

Accordingly, the operation (S101 to S104) for eliminating the leakage signal from the third frequency signal output by the frequency converter 103 by using the first frequency signal output by the local oscillator 101 is repeated until the leakage signal is eliminated from the third frequency signal.

As described above, the leakage signal reducing device according to the exemplary embodiment of the present invention removes the leakage signal of the local oscillator included in the output signal of the frequency converter caused by the DC offset, substrate coupling, and parasitic components of the circuit in a multi-band signal generating system.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for reducing a leakage signal in a system for generating a multi-band signal, comprising:
generating a first frequency signal through a local oscillator;
generating a second frequency signal generated by dividing the first frequency signal with a divider;
generating a third frequency signal through a frequency converter by using the first frequency signal and the second frequency signal;
generating a first signal by adjusting a phase and a gain of the first frequency signal through a variable phase transitor and a variable gain adjuster;
generating a second signal by adding the first signal and the third frequency signal; and
controlling a phase adjust value of the variable phase transitor and a gain adjust ratio of the variable gain adjuster based on power of the second signal so as to reduce the leakage signal included in the third frequency signal.

2. The method of claim 1, further including
repeating the generation of the first signal, the generation of the second signal, and the controlling until the leakage signal is eliminated from the second signal.

3. The method of claim 2, wherein
the controlling includes
controlling the phase adjust value and the gain adjust ratio so as to reduce the second signal.

4. The method of claim 2, wherein
the controlling includes
measuring power of signals of frequency bandwidths included in the second signal.

5. The method of claim 2, wherein
the controlling includes
measuring power of a signal with the same frequency bandwidth as the first frequency signal from among the signals included in the second signal.

6. The method of claim 1, wherein
is the third frequency signal includes a signal of a frequency bandwidth corresponding to the sum of frequencies of the first frequency signal and the second frequency signal and a signal of a frequency bandwidth corresponding to the difference between the frequencies of the first frequency signal and the second frequency signal.

7. The method of claim 6, wherein
the third frequency signal includes the leakage signal leaked to an output of the frequency converter from the local oscillator.

8. A device for reducing a leakage signal in a system for generating a multi-band signal comprising:
a local oscillator for generating a first frequency signal;
a divider for generating a second frequency signal by dividing the first frequency signal;
a frequency converter for generating a third frequency signal by using the first frequency signal and the second frequency signal;
a variable phase transitor for adjusting and outputting a phase of the first frequency signal;
a variable gain amplifier for adjusting and outputting a gain of an output signal of the variable phase transitor;
an operator for operating the third frequency signal and an output signal of the variable gain amplifier; and
a controller for controlling a phase adjust value of the variable phase transitor and a gain adjust ratio of the variable gain amplifier so as to reduce power of the signal output by the operator.

9. The device of claim 8, further including
a power measurer for measuring power of a signal output by the operator and outputting the power to the controller.

10. The device of claim 8, wherein
the operator adds the third frequency signal and the output signal of the variable gain amplifier, and outputs the added signal.

11. The device of claim 10, wherein
the third frequency signal includes a leakage signal leaked to the frequency converter from the local oscillator, and
the controller controls the phase adjust value and the gain adjust ratio so as to reduce the leakage signal from the third frequency signal.

12. The device of claim 11, wherein
the controller controls the phase adjust value so that a phase of an output signal of the variable phase transitor may be opposite to the phase of the leakage signal, and it controls the gain adjust ratio variable so that the gain adjust ratio of the gain amplifier may correspond to the leakage ratio of the leakage signal.
